(19) United States
(12) Patent Application Publication
(10) Pub. No.: US 2017/0277338 A1
(43) Pub. Date: Sep. 28, 2017

(54) CONTROL METHOD FOR TERMINAL AND TERMINAL

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/335,398

(22) Filed: Oct. 26, 2016

Related U.S. Application Data
(63) Continuation of application No. PCT/CN2016/096431, filed on Aug. 23, 2016.

(30) Foreign Application Priority Data
Mar. 25, 2016 (CN) 2016101799152

(51) Int. Cl. G06F 3/041; G06F 3/0488

(52) U.S. Cl. CPC G06F 3/0416; G06F 3/04883; G06F 3/04842

(57) ABSTRACT

Embodiments of the present disclosure provide a control method and device for a terminal. The control method for the terminal provided by the embodiments of the present disclosure comprises: acquiring operation information of a user at an edge touch area of the terminal in a screen locking state; and controlling the terminal to execute unlocking operation according to the operation information of the user at the edge touch area of the terminal. With the technical solutions of the present disclosure, when the terminal is controlled to unlock, the operation is simple and convenient, the unlocking efficiency of the terminal is improved. The problem that the unlocking efficiency of the terminal is relatively low due to inconvenient operation when the terminal with a large touch screen is unlocked with one hand in the prior art can be solved

### CROSS REFERENCE TO RELATED APPLICATION

The present application is a continuation of International Application No. PCT/CN2016/096431, filed on 23 Aug. 2016 which is based upon and claims the priority of Chinese Patent Application No. 2016101799152, filed in the Patent Office of the P.R.C. on Mar. 25, 2016, and entitled “CONTROL METHOD FOR TERMINAL AND TERMINAL”, the entire contents of which are incorporated herein by reference.

### TECHNICAL FIELD

The present disclosure relates to the technical field of communications, and particularly relates to a control method for a terminal and the terminal.

### BACKGROUND

With the development of science and the progress of technology, intelligent terminals are used increasingly popular. In order to improve the use efficiency and enhance good user experience, the existing intelligent terminals mostly interact with users by adopting touch screens.

The interaction mode between a user and a terminal is mainly realized by clicking a functional key on the screen or realized by swiping operation on the screen. When the user operates on the screen, the terminal detects the operation being carried out by the user by detecting the touch position of a finger.

In the process of implementing the present disclosure, the inventor discovers that the prior art at least has the following problems: when a user uses a terminal with a large screen, a cursor on the screen of the terminal cannot be accurately and quickly controlled by one-hand operation of the user, and the operation is inconvenient, so that the operation cost is relatively high and the control efficiency is relatively low.

### SUMMARY

In view of this, the embodiments of the present disclosure provide a control method for a terminal and the terminal for solving the problems that the operation cost is relatively high and the control efficiency is relatively low when a cursor on a screen of the terminal is controlled in the prior art.

To fulfill the above inventive object, in one aspect, an embodiment of the present disclosure provides a control method for a terminal, including: acquiring operation information of a user at an edge touch area of the terminal; and controlling a cursor on a screen of the terminal according to the operation information.

To fulfill the above inventive object, in another aspect, an embodiment of the present disclosure further provides a terminal, including: an acquisition module, used for acquiring operation information of a user at an edge touch area of the terminal; and a control module, used for controlling a cursor on a screen of the terminal according to the operation information.

To fulfill the above inventive object, in a further aspect, an embodiment of the present disclosure further provides a terminal, including at least one processor and a memory in communication connection with the at least one processor, wherein the memory stores instructions executable by the at least one processor, and the instructions are executed by the at least one processor, so that the at least one processor can: acquire operation information of a user at an edge touch area of the terminal; and control a cursor on a screen of the terminal according to the operation information.

To fulfill the above inventive object, in a further aspect, an embodiment of the present disclosure further provides a non-transient computer readable storage medium, which stores computer executable instructions, the computer executable instructions are used for: acquiring operation information of a user at an edge touch area of the terminal; and controlling a cursor on a screen of the terminal according to the operation information.

### BRIEF DESCRIPTION OF THE DRAWINGS

One or more embodiments are illustrated by way of example via figures in corresponding drawings, these illustrations do not limit the embodiments, components with the same reference numerical signs in the drawings represent similar elements, and the figures in the drawings do not have proportional limitations unless otherwise specified.

FIG. 1 is a flow diagram of a control method for a terminal provided by an embodiment of the present disclosure;

FIG. 2 is a structural schematic diagram of a terminal provided by an embodiment of the present disclosure;

FIG. 3 is a schematic diagram of a hardware structure of a terminal for executing the control method for the terminal provided by an embodiment of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

It should be clear that the described embodiments are merely part of, not all of the embodiments of the present disclosure. Based on the embodiments in the present disclosure, all other embodiments obtained by those of ordinary skill in the art without any creative effort shall be within the protection scope of the present disclosure.

The terms used in the embodiments of the present disclosure are for describing specific embodiments only, rather than limiting the present disclosure. Singular forms “one”, “said” and “the” used in the embodiments and the appended claims of the present disclosure also intend to include plural forms, unless the context clearly expresses other meanings.

Upon the context, the word “if” used herein can be interpreted as “at the time of . . . ” or “when . . . ” or “responding to determining” or “responding to detecting”. Similarly, upon the context, the phrase “if determining” or “if detecting (the stated condition or event)” can be interpreted as “when determining” or “responding to determining” or “when detecting (the stated condition or event)” or “responding to detecting (the stated condition or event)”.

### Embodiment 1

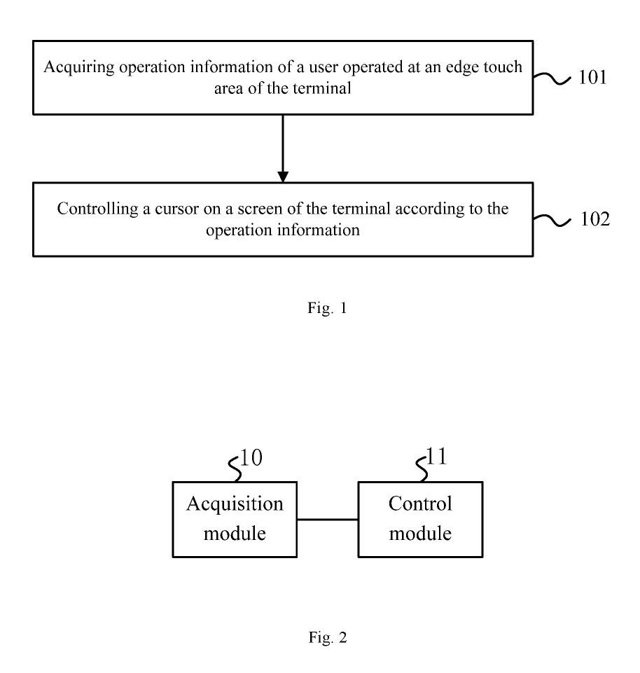

FIG. 1 is a flow diagram of a control method for a terminal according to an embodiment of the present disclosure. As shown in FIG. 1, the control method for the terminal in this embodiment may specifically include steps 101˜102 below.

101, acquiring operation information of a user at an edge touch area of the terminal.

When a user uses a terminal, since the size of the screen is beyond the range of one-hand operation, difficult one-hand operation may occur frequently. Thus, the embodiment of the present disclosure provides a method for controlling a cursor on a screen of the terminal by operating the terminal at the edge touch area of the terminal.

Before the cursor on the screen of the terminal is controlled, a mouse function needs to be opened in the terminal, so that the cursor can appear on the screen of the terminal.

It should be noted that the terminal involved in the embodiment of the present disclosure may include but not limited to a personal computer (PC), a personal digital assistant (PDA), a wireless handheld device, a tablet computer, a mobile phone, an MP3 player, an MP4 player, etc.

In the embodiment of the present disclosure, the operation information of the user at the edge touch area of the terminal may include but not limited to: operation information generated after swiping operation of the user at the edge touch area of the terminal; or operation information generated after clicking operation of the user at the edge touch area of the terminal; or operation information generated after pressing operation of the user at the edge touch area of the terminal.

It could be understood that edge touch refers to providing input via the edge, the border or the back of the terminal to track clicking, swiping or pressing operation of a finger on the edge of the terminal so as to control the terminal.

The edge touch area of the terminal may be an area that the thumb of the user can reach on the sides of the terminal when the user naturally holds the terminal, and the sides of the terminal may include other four sides except the front side and the back side.

In the embodiment of the present disclosure, the edge touch area of the terminal may be realized by a physical key, a virtual key, a sensor or a screen.

For example, if the terminal employs a curved screen, the edge touch area of the terminal can be realized by the edge screen of the curved screen. Taking a capacitive touch screen as an example for illustration, when the finger of the user touches the edge touch screen, the capacitance of a touch spot is changed, so that the frequency of an oscillator connected with a capacitor is changed, the touch position can be determined by measuring the change of the frequency of the oscillator, and then the operation information of the user at the edge touch area of the terminal can be acquired.

For another example, if physical keys for adjusting the volume are at the edge of the terminal, taking the physical keys for adjusting the volume in the terminal as an example for illustration, when the finger of the user presses a physical key for adjusting the volume, the terminal may learn that the user presses the key for turning up the volume or the key for turning down the volume, and similarly, if the user performs pressing operation at the edge touch area, the operation information of the user at the edge touch area of the terminal can be acquired.

As another example, if virtual keys with certain functions are at the edge of the terminal and when the virtual keys are capacitive virtual keys, the terminal judges which virtual key the user touches via the capacitance of the capacitive virtual keys. Specifically, the finger and the electrode plate in a capacitive virtual key may form a capacitor when the user touches the capacitive virtual key, the terminal determines the touch position of the user by detecting the change of the capacitance so as to determine which virtual key the user touches, and then the operation information of the user at the edge touch area of the terminal can be acquired.

As another example, if sensors with certain functions are arranged at the edge of the terminal, taking the sensors which are pressure sensors on the terminal as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, and after acquiring the electrical signal, the terminal can determine which pressure sensor the user presses or which position on the pressure sensor the user presses so as to determine which function of the pressure sensor the user presses, and then acquire the operation information of the user at the edge touch area of the terminal. In addition, the sensors with certain functions at the edge of the terminal may also be photo sensors.

102, controlling a cursor on a screen of the terminal according to the operation information.

The cursor on the screen of the terminal is correspondingly controlled by acquiring the operation information of the user at the edge touch area of the terminal.

Specifically, if the operation information of the user at the edge touch area of the terminal is operation information generated after swiping operation of the user at the edge touch area of the terminal, the method of controlling a cursor on a screen of the terminal according to the operation information may include but not limited to: determining the swiping direction of the user at the edge touch area of the terminal according to the operation information generated after swiping operation of the user at the edge touch area of the terminal; and controlling the moving direction of the cursor on the screen of the terminal according to the swiping direction.

For example, if the terminal uses a curved screen, the edge touch area of the terminal can be realized by the edge screen of the curved screen. Taking a capacitive touch screen as an example for illustration, the index finger of the user carries out swiping operation at the edge touch area of the terminal, wherein the swiping operation may be upward swiping, downward swiping, leftward swiping or rightward swiping, etc. When the index finger of the user swipes leftwards, the terminal determines the swiping direction of the index finger of the user by detecting the change of the capacitance, then leftward swiping of the index finger of the user can be determined, operation information about leftward swiping operation of the user at the edge touch area of the terminal is generated, and the cursor on the screen of the terminal is controlled to swipe leftwards according to the leftward swiping direction.

Similarly, when the index finger of the user swipes to other directions, the terminal controls the moving direction of a mouse on the screen of the terminal in the same way.

Or, the operation of the user at the edge touch area of the terminal may also be pressing operation. When the operation information of the user at the edge touch area of the terminal is operation information generated after pressing operation of the user at the edge touch area of the terminal, the method of controlling a cursor on a screen of the terminal may include but not limited to: controlling the cursor on the screen of the terminal to select specified content according to the operation information generated after pressing operation of the user at the edge touch area of the terminal.

For example, if the edge touch area of the terminal is a physical key, when the finger of the user presses the physical key, the terminal may acquire the physical key pressing number of the user, and the operation information of the user at the edge touch area of the terminal can thus be acquired. If the physical key is continuously pressed twice, the cursor on the screen of the terminal is controlled to select specified content in the text displayed by the screen of the terminal, e.g., a few characters ahead of the cursor, a few characters behind the cursor, etc.

Or, the operation of the user at the edge touch area of the terminal may also be a clicking operation. Specifically, if the operation information of the user at the edge touch area of the terminal is operation information generated after clicking operation of the user at the edge touch area of the terminal, the method of controlling a cursor on a screen of the terminal may include but not limited to: determining the clicking position of the user at the edge touch area of the terminal according to the operation information generated after clicking operation of the user at the edge touch area of the terminal; and controlling the cursor on the screen of the terminal to move to a position corresponding to the clicking position.

For example, if two virtual keys with certain functions are at the edge of the terminal and when the two virtual keys are capacitive virtual keys, the finger of the user carries out clicking operation on the edge touch area of the terminal, the terminal judges which virtual key the user clicks via the capacitance of the capacitive virtual keys. Specifically, the finger and the electrode plate in a capacitive virtual key may form a capacitor when the user contacts the determined key, the terminal determines whether the user clicks the two virtual keys and which virtual key the user specifically clicks by detecting the change of the capacitance, and the cursor on the screen of the terminal can be controlled to move to a position corresponding to the clicking position, for example, a virtual key A corresponds to the head of the text, and another virtual key B corresponds to the tail of the text.

According to the control method for the terminal provided by the embodiment of the present disclosure, operation information of a user at an edge touch area of the terminal is acquired, and a cursor on a screen of the terminal is controlled according to the acquired operation information, so that the cursor on the screen of the terminal can be controlled using the edge touch area of the terminal, the problems that the operation cost is relatively high and the control efficiency is relatively low when the cursor on the screen of the terminal is controlled in the prior art are solved, the cursor on the screen of the terminal can be accurately controlled, the control cost can be reduced and the control efficiency can be improved.

### Embodiment 2

An embodiment of the present disclosure further gives a device embodiment for implementing the steps and the methods in the above method embodiment. FIG. 2 is a structural schematic diagram of a terminal provided by an embodiment of the present disclosure. As shown in FIG. 2, the terminal of this embodiment includes an acquisition module 11 and a control module 12.

The acquisition module 11 is used for acquiring operation information of a user at an edge touch area of the terminal.

The control module 12 is used for controlling a cursor on a screen of the terminal according to the operation information acquired by the acquisition module 11.

The operation information of the user at the edge touch area of the terminal includes: operation information generated after swiping operation of the user at the edge touch area of the terminal; or operation information generated after clicking operation of the user at the edge touch area of the terminal; or operation information generated after pressing operation of the user at the edge touch area of the terminal.

In a possible implementation way, if the operation information of the user at the edge touch area of the terminal is operation information generated after swiping operation of the user at the edge touch area of the terminal, the control module 12 is specifically used for: determining the swiping direction of the user at the edge touch area of the terminal according to the operation information generated after swiping operation of the user at the edge touch area of the terminal and acquired by the acquisition module 11; and controlling the moving direction of the cursor on the screen of the terminal according to the swiping direction.

In a possible implementation way, if the operation information of the user at the edge touch area of the terminal is operation information generated after pressing operation of the user at the edge touch area of the terminal, the control module 12 is specifically used for controlling the cursor on the screen of the terminal to select specified content according to the operation information generated after pressing operation of the user at the edge touch area of the terminal and acquired by the acquisition module 11.

In a possible implementation way, if the operation information of the user at the edge touch area of the terminal is operation information generated after clicking operation of the user at the edge touch area of the terminal, the control module 12 is specifically used for: determining the clicking position of the user at the edge touch area of the terminal according to the operation information generated after clicking operation of the user at the edge touch area of the terminal and acquired by the acquisition module 11; and controlling the cursor on the screen of the terminal to move to a position corresponding to the clicking position.

The terminal provided by the embodiment of the present disclosure can be used for executing the technical solution of the method embodiment shown in FIG. 1, and its implementation principle and advantages are similar and are thus not redundantly described herein.

According to the terminal of the present disclosure, an acquisition module 11 in the terminal acquires operation information of a user at an edge touch area of the terminal, and a control module 12 controls a cursor on a screen of the terminal according to the operation information acquired by the acquisition module, so that the cursor on the screen of the terminal can be controlled using the edge touch area of the terminal, the problems that the operation cost is relatively high and the control efficiency is relatively low when the cursor on the screen of the terminal is controlled in the prior art are solved, the cursor on the screen of the terminal can be accurately controlled, the control cost can be reduced and the control efficiency can be improved.

### Embodiment 3

An embodiment of the present disclosure provides a non-volatile computer storage medium, the computer storage medium stores computer executable instructions, and the computer executable instructions can execute the processing method in any above method embodiment.

### Embodiment 4

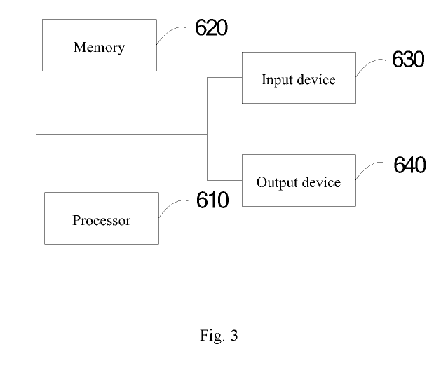

FIG. 3 is a schematic diagram of a hardware structure of a terminal for executing the control method for the terminal provided by an embodiment of the present disclosure. As shown in FIG. 3, the terminal includes one or more processors 610 and a memory 620. One processor 610 is taken as an example in FIG. 3. The terminal may further include an input device 630 and an output device 640.

The processor 610, the memory 620, the input device 630 and the output device 640 can be connected via a bus or in other mode, taking bus connection as an example in FIG. 3.

The memory 620 serving as a non-volatile computer readable storage medium can be used for storing non-volatile software programs, non-volatile computer executable programs and modules. The processor 610 runs the non-volatile software programs, instructions and modules stored in the memory 620 to execute various functional disclosures and data processing of the terminal, i.e., to implement the processing methods in the above method embodiment.

The memory 620 may include a program storage area and a data storage area, wherein the program storage area can store an operating system and an disclosure program required by at least one function; and the data storage area can store data and the like. Moreover, the memory 620 may include a high-speed random access memory, and may also include a non-volatile memory, e.g., at least one disk storage device, a flash device or other non-volatile solid-state storage device. In some embodiments, the memory 620 may include memories arranged remotely relative to the processor 610, and these remote memories can be connected to the processor via a network. The example of the network includes but not limited to the internet, an intranet, a local area network, a mobile communication network and a combination thereof.

The input device 630 can receive input digital or character information and generate signal input. The output device 640 may include display equipment such as a display screen.

The one or more modules are stored in the memory 620, and are executed by the one or more processors 610 to execute: acquiring operation information of a user at an edge touch area of the terminal; and controlling a cursor on a screen of the terminal according to the operation information.

In a possible implementation way, the operation information of the user at the edge touch area of the terminal includes: operation information generated after swiping operation of the user at the edge touch area of the terminal; or operation information generated after clicking operation of the user at the edge touch area of the terminal; or operation information generated after pressing operation of the user at the edge touch area of the terminal.

In a possible implementation way, the operation information of the user at the edge touch area of the terminal is operation information generated after swiping operation of the user at the edge touch area of the terminal; the controlling a cursor on a screen of the terminal according to the operation information includes: determining the swiping direction of the user at the edge touch area of the terminal according to the operation information generated after swiping operation of the user at the edge touch area of the terminal; and controlling the moving direction of the cursor on the screen of the terminal according to the swiping direction.

In a possible implementation way, the operation information of the user at the edge touch area of the terminal is operation information generated after pressing operation of the user at the edge touch area of the terminal; the controlling a cursor on a screen of the terminal according to the operation information includes: controlling the cursor on the screen of the terminal to select specified content according to the operation information generated after pressing operation of the user at the edge touch area of the terminal.

In a possible implementation way, the operation information of the user at the edge touch area of the terminal is operation information generated after clicking operation of the user at the edge touch area of the terminal; the controlling a cursor on a screen of the terminal according to the operation information includes: determining the clicking position of the user at the edge touch area of the terminal according to the operation information generated after clicking operation of the user at the edge touch area of the terminal; and controlling the cursor on the screen of the terminal to move to a position corresponding to the clicking position.

The above product can execute the method provided by the embodiment of the present disclosure, and has corresponding functional modules for executing the method and corresponding advantages. For the technical details not described in detail in this embodiment, reference may be made to the method provided by the embodiment of the present disclosure.

The terminal in the embodiments of the present disclosure exists in multiple forms, including but not limited to:

Mobile communication equipment: this type of equipment is characterized by a mobile communication function, and has main goals of providing voice and data communication. The terminal includes a smart phone (e.g., iPhone), a multimedia phone, a functional phone, a low-end phone, etc.

Ultra-mobile personal computer equipment: this type of equipment belongs to the scope of personal computers, has computing and processing functions, and generally also has mobile internet characteristic. The terminal includes PAD, an MID (Mobile Internet Device) and UMPC (Ultra Mobile Personal Computer) equipment and the like, e.g., iPad.

Portable entertainment equipment: this type of equipment can display and play multimedia contents. The equipment includes audio and video players (e.g., iPod), a handheld game player, an electronic book, an intelligent toy and portable vehicle-mounted navigation equipment.

Server: equipment for providing computing services, including a processor, a hard disk, a memory, a system bus, etc., wherein the architecture of the server is similar to that of a general computer, but the server is highly required on the aspects of processing capability, stability, reliability, security, expandability, manageability and the like because it needs to provide highly reliable services.

Other electronic devices with a data interaction function.

The above-described device embodiment is only schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs.

Upon the descriptions of the above embodiments, those skilled in the art can clearly learn that each embodiment can be realized by means of software and a general hardware platform, and of course, can be realized via hardware. Based on such an understanding, the above technical solutions substantially or the parts making contribution to relevant technologies may be embodied in the form of a software product, and the computer software product can be stored in a computer readable storage medium, such as an ROM (Read-Only Memory)/RAM (Random Access Memory), a magnetic disk, an optical disk, etc., which includes a plurality of instructions enabling computer equipment (which may be a personal computer, a server, or network equipment or the like) to execute each embodiment or the method in some part of each embodiment.

Finally, it should be noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the present disclosure.

### INDUSTRIAL APPLICABILITY

According to the control method for the terminal and the terminal provided by the embodiments of the present disclosure, operation information of a user at an edge touch area of the terminal is acquired, and a cursor on a screen of the terminal is controlled according to the operation information, so that the cursor on the screen of the terminal can be accurately controlled, the control cost can be reduced and the control efficiency can be improved.

1. A control method for a terminal, comprising:
acquiring operation information of a user operated at an edge touch area of the terminal; and
controlling a cursor on a screen of the terminal according to the operation information.

2. The method according to claim 1, wherein the operation information of the user at the edge touch area of the terminal comprises:
operation information generated after swiping operation of the user at the edge touch area of the terminal; or
operation information generated after clicking operation of the user at the edge touch area of the terminal; or
operation information generated after pressing operation of the user at the edge touch area of the terminal.

3. The method according to claim 2, wherein the operation information of the user at the edge touch area of the terminal is operation information generated after the user swipes at the edge touch area of the terminal;
wherein the controlling a cursor on a screen of the terminal according to the operation information comprises:
determining swiping direction of the user at the edge touch area of the terminal according to the operation information generated after swiping operation of the user at the edge touch area of the terminal; and
controlling the moving direction of the cursor on the screen of the terminal according to the swiping direction.

4. The method according to claim 2, wherein the operation information of the user at the edge touch area of the terminal is operation information generated after pressing operation of the user at the edge touch area of the terminal; and
wherein the controlling a cursor on a screen of the terminal according to the operation information comprises:
controlling the cursor on the screen of the terminal to select specified content according to the operation information generated after pressing operation of the user at the edge touch area of the terminal.

5. The method according to claim 2, wherein the operation information of the user at the edge touch area of the terminal is operation information generated after clicking operation of the user at the edge touch area of the terminal;
wherein the controlling a cursor on a screen of the terminal according to the operation information comprises:
determining the clicking position of the user at the edge touch area of the terminal according to the operation information generated after clicking operation of the user at the edge touch area of the terminal; and
controlling the cursor on the screen of the terminal to move to a position corresponding to the clicking position.

6. A terminal, comprising:
at least one processor; and
a memory in communication connection with the at least one processor, wherein
the memory stores instructions executable by the at least one processor, and the instructions are executed by the at least one processor, so that the at least one processor can:
acquire operation information of a user operated at an edge touch area of the terminal; and
control a cursor on a screen of the terminal according to the operation information.

7. The terminal according to claim 6, wherein the operation information of the user at the edge touch area of the terminal comprises:
operation information generated after swiping operation of the user at the edge touch area of the terminal; or
operation information generated after clicking operation of the user at the edge touch area of the terminal; or
operation information generated after pressing operation of the user at the edge touch area of the terminal.

8. The terminal according to claim 7, wherein the operation information of the user at the edge touch area of the terminal is operation information generated after swiping operation of the user at the edge touch area of the terminal;
wherein the controlling a cursor on a screen of the terminal according to the operation information comprises:
determining the swiping direction of the user at the edge touch area of the terminal according to the operation information generated after swiping operation of the user at the edge touch area of the terminal; and
controlling the moving direction of the cursor on the screen of the terminal according to the swiping direction.

9. The terminal according to claim 7, wherein the operation information of the user at the edge touch area of the terminal is operation information generated after pressing operation of the user at the edge touch area of the terminal; and
wherein the controlling a cursor on a screen of the terminal according to the operation information comprises:
controlling the cursor on the screen of the terminal to select specified content according to the operation information generated after pressing operation of the user at the edge touch area of the terminal.

10. The terminal according to claim 7, wherein the operation information of the user at the edge touch area of the terminal is operation information generated after clicking operation of the user at the edge touch area of the terminal;
wherein the controlling a cursor on a screen of the terminal according to the operation information comprises:
determining the clicking position of the user at the edge touch area of the terminal according to the operation information generated after clicking operation of the user at the edge touch area of the terminal; and
controlling the cursor on the screen of the terminal to move to a position corresponding to the clicking position.

11. A non-transient computer readable storage medium, wherein the non-transient computer readable storage medium stores computer executable instructions, which are used for:
acquiring operation information of a user at an edge touch area of the terminal; and
controlling a cursor on a screen of the terminal according to the operation information.

12. The non-transient computer readable storage medium according to claim 11, wherein the operation information of the user at the edge touch area of the terminal comprises:
operation information generated after swiping operation of the user at the edge touch area of the terminal; or
operation information generated after clicking operation of the user at the edge touch area of the terminal; or
operation information generated after pressing operation of the user at the edge touch area of the terminal.

13. The non-transient computer readable storage medium according to claim 12, wherein the operation information of the user at the edge touch area of the terminal is operation information generated after swiping operation of the user at the edge touch area of the terminal;
wherein the controlling a cursor on a screen of the terminal according to the operation information comprises:
determining the swiping direction of the user at the edge touch area of the terminal according to the operation information generated after swiping operation of the user at the edge touch area of the terminal; and
controlling the moving direction of the cursor on the screen of the terminal according to the swiping direction.

14. The non-transient computer readable storage medium according to claim 12, wherein the operation information of the user at the edge touch area of the terminal is operation information generated after pressing operation of the user at the edge touch area of the terminal; and
wherein the controlling a cursor on a screen of the terminal according to the operation information comprises:
controlling the cursor on the screen of the terminal to select specified content according to the operation information generated after pressing operation of the user at the edge touch area of the terminal.

15. The non-transient computer readable storage medium according to claim 12, wherein the operation information of the user at the edge touch area of the terminal is operation information generated after clicking operation of the user at the edge touch area of the terminal;
wherein the controlling a cursor on a screen of the terminal according to the operation information comprises:
determining the clicking position of the user at the edge touch area of the terminal according to the operation information generated after clicking operation of the user at the edge touch area of the terminal; and
controlling the cursor on the screen of the terminal to move to a position corresponding to the clicking position.
